(19) United States
(12) Patent Application Publication
(10) Pub. No.: US 2005/0245141 A1
(43) Pub. Date: Nov. 3, 2005

(54) Flexible cable sleeve and apparatus

(76) Inventor: Juan Triola Ifort, Santa Cruz de Tenerife (ES)

Correspondence Address: Sanchelima and Associates, P. A.;Jesus Sanchelima, Esq., 235 S.W. Le Jeune Rd., Miami, FL, 33134, US

(21) Appl. No.: 10/836,868

(22) Filed: May 3, 2004

(51) Int. Cl. H01R 4/28

(52) U.S. Cl. 439/761

(57) ABSTRACT

A flexible sleeve and tool for mounting the flexible sleeve intended to hold more than one cable/wire together. The sleeve includes repetitive cuts cooperatively positioned to enhance the flexibility of the sleeve. The tool includes two half portions hingedly mounted to each other with complementing ends. A spring member biases the half portions to urge the complementing ends against each other. The half portions include cylindrical halves and complementary half tubular members extending respectively from the former at an angle. The half tubular members as well as the cylindrical halves define a common open end and the opposite end of the cylindrical halves defines a round end when closed. The opposite ends of the half tubular members define open ends. When the tool is at rest, it provides a round shape to initiate the separation of the flexible sleeve.

### BACKGROUND OF THE INVENTION

1. Field of the Invention

The present invention relates to a flexible cable sleeve and apparatus for using it, and more particularly, to a sleeve for holding more than one cable or wire together to protect them while allowing the user to add or remove one or more wires or cables, and the apparatus used to facilitate its ready installation.

2. Description of the Related Art

Several designs for flexible cable sleeves have been developed in the past. One of the problems with the currently available sleeves is their lack of flexibility, which is necessary to route the cables properly. None of them, however, includes a flexible sleeve for holding and protect cables and/or wires that also allows the user to easily add additional cables and/or wires or remove any one of the previously bunched cables and/or wires while keeping the cables and/or wires still bound and protected. The sleeve is provided with repeating cuts that cooperate to permit its bending in all directions.

With respect to the apparatus for inserting the cables to be protected within the sleeve subject of the present application, applicant is not aware of any such apparatus.

Applicant knows of the existence of cable ducts, channels and surface raceways mountable to the base of walls and partitions for conventional wire enclosure applications including telecommunication cabling. These cable ducts and raceways may be opened by removing the outer sections to allow the insertion of cables or replacing them when damaged. These cable ducts and raceways are permanent fixtures, which do not allow the incorporation of generally shorter length cables from conventional electrical household appliances. The loose cables for appliances such as speaker, audio/visual equipments, computer, printers, etc., represent a potential safety hazard when located near radiators, over floors or when trapped under furniture. There is no suitable device for releasably mounting and protecting these relatively short cables. It is difficult to house within permanent ducts or channels all appliance cables while still providing the necessary flexibility to route the sleeve and cables in any desired direction.

Applicant believes that one of the related references corresponds to French Patent No. 2,699,013, issued to Jean-Claude Douchet on Jun. 10, 1994, for an annular shaped raceway for the accommodation of electrical cables, formed by readily detachable components. However, it differs from the present invention because Douchet's patented invention does not provide for the insertion or removal of cables as in the present invention.

Applicant believes that another related reference corresponds to French Patent No. 2,744,280, issued to Beaulat Bernard on Aug. 1, 1997 31, 1996, for a sheath for wiring bundles formed by a laminar shell wound to form a spiral to accommodate cables. However, it differs from the present invention because in the Bernard's patented invention the sleeve does not include cuts that enhance its flexibility. Additionally, the present invention includes a device for mounting the sleeve to the cables and/or wires.

Applicant believes that another related reference corresponds to U.S. Pat. No. 3,340,900, issued to J. G. Spurlock on Sep. 12, 1967, for a flexible metal hose for cables including a helically wound strip of galvanized metal, accommodating cables within channels set in the inner and outer surface of the strip. When the flexible metal hose is wound, allows the edges of individual windings to engage in each other to close the perimeter of the hose. However, it differs from the present invention because the Spurlock's patented invention hold only one cable. Also, since in Spurlock's patented invention the cable is wounded, it does not possibility the insertion or removing of cables easily as the present invention.

Applicant believes that another related reference corresponds to U.S. Pat. No. 4,018,983, issued to J. Watson Pedlow on Apr. 19, 1977, for a plastic tubular sheath, which, when it is longitudinally overlapped, allows the accommodation of electrical and telephone cables, and the like. However, it differs from the present invention because Pedlow's patented invention does not include cuts that enhance its flexibility. Additionally, the present invention includes a device for mounting the sleeve to the cables and/or wires.

Applicant believes that another related reference corresponds to U.S. Pat. No. 6,012,494, issued to Matthias Balazs on Jan. 11, 2000, for an flexible structure, which houses and protects electrical cables. However, it provide full protection to the cables therein. Also, since Balazs' patented invention is a cylindrical closed structure, it does not possibility the insertion or removing the cables as the present invention does. Additionally, the present invention includes a device for mounting the sleeve to the cables and/or wires. None of these references, however, includes a device that allows the user easily mount cable sleeves to protect wires.

Other patents describing the closest subject matter provide for a number of more or less complicated features that fail to solve the problem in an efficient and economical way. None of these patents suggest the novel features of the present invention.

### SUMMARY OF THE INVENTION

It is one of the objects of this invention to provide a flexible sleeve to keep more than one cable together.

It is one of the objects of the present invention to provide a device for readily mounting the sleeve to the cables and/or wires.

It is still another object of the present invention to provide a flexible cable sleeve that can be mounted arround the cables and/or wires in all directions and positions even in the wall corners.

It is still another object of the present invention to provide a flexible cable sleeve that can be mounted to different furniture pieces.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of the clip tool holding several cables and ready to accept the sleeve subject of the present application.

FIG. 2 shows a front elevational view of the clip tool represented in FIG. 1, in the open position for receiving the cables.

FIG. 3 is an isometric view of the clip tool and the flexible sleeve being mounted over the cables represented in FIGS. 1 and 2.

FIG. 4 represents a side elevational view of the flexible sleeve, used with present invention.

FIG. 5 shows an end elevational view of the flexible sleeve represented in FIG. 4.

FIG. 6 illustrates a top view of the flexible sleeve shown in FIGS. 4 and 5.

FIG. 7 is a side elevational view of the flexible sleeve, from the side opposite to the one shown in FIG. 4.

### DETAILED DESCRIPTION OF THE PREFERRED EMBODIMENT

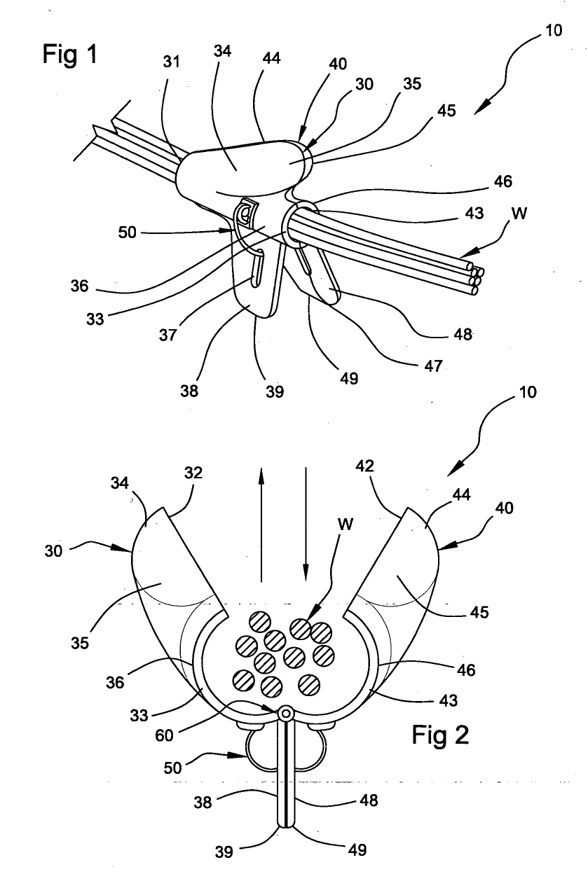

Referring now to the drawings, where the apparatus or tool subject of the present application is generally referred to with numeral 10, it can be observed that it basically includes half portions 30 and 40 that are hingedly mounted to each other with hinge 60. Spring member 50 biases portions 30 and 40 to urge ends 32 and 42 against each other. Portions 30 and 40 include complementary cylindrical halves 34 and 44 adjacent to ends 32 and 42. Half members 34 and 44 include round ends 35 and 45 that complement each other, when tool 10 is at rest, to provide a round shape to initiate the separation of flexible sleeve 20, as seen in FIGS. 1 and 2.

As best seen in FIG. 1, complementary half tubular members 36 and 46 extend respectively form cylindrical halves 34 and 44 at an angle of approximately 30 degrees, in the preferred embodiment. The angle can be varied between 15 and 60 degrees and the inventor prefers 30 degrees. Half tubular members 36 and 46 as well as cylindrical halves 34 and 44 define common open end 31 when tool 10 is closed. The opposite ends of cylindrical halves 34 and 44 define round ends 35 and 45. The opposite ends of half tubular members 36 and 46 define open ends 33 and 43, as best seen in FIG. 2.

Handle members 38 and 48 extend from complementary half tubular members 36 and 46 and include through openings 37 and 47 and ends 39 and 49 coacting against complementary half tubular members 36 and 46, respectively, urging the latter against each other.

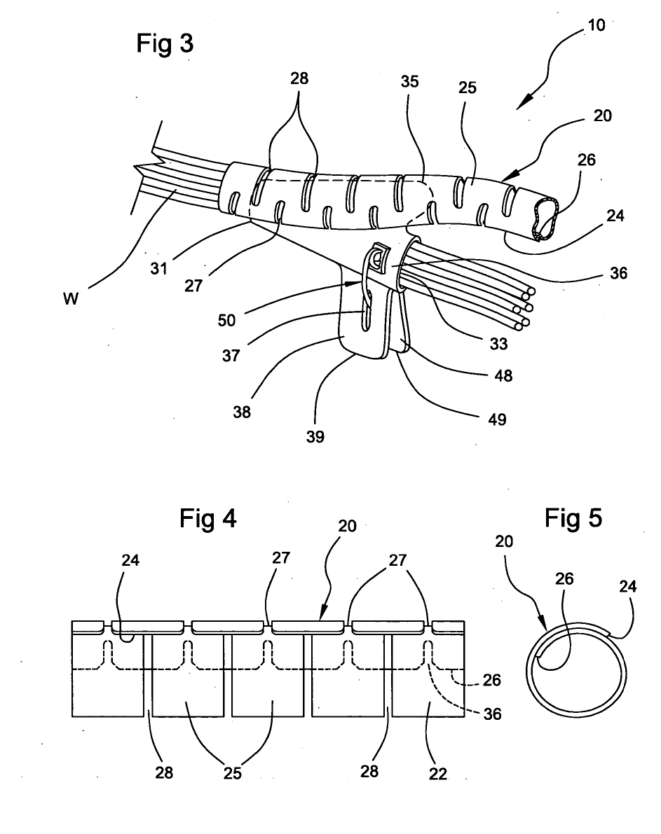

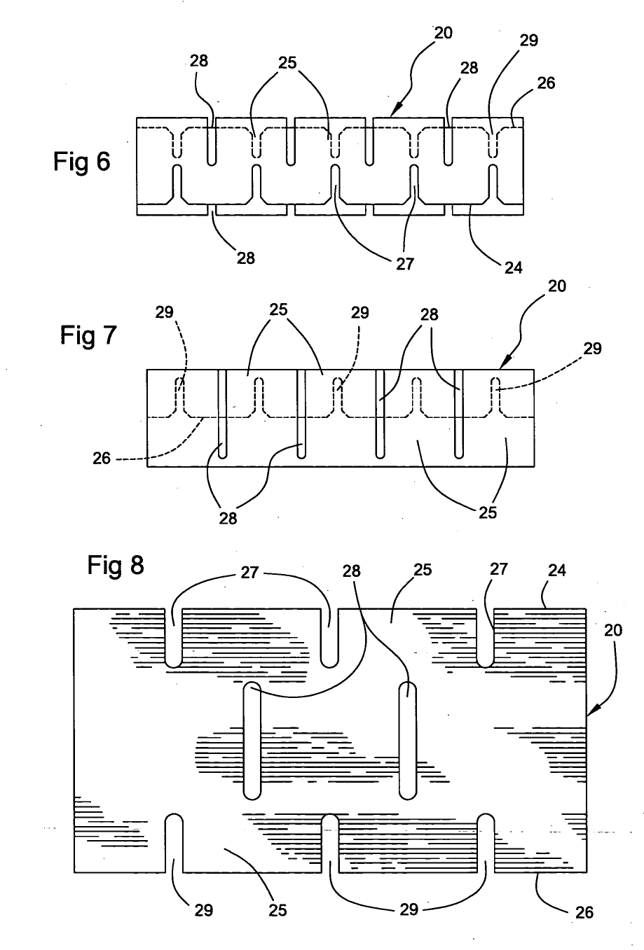

FIGS. 4; 5; 6; 7 and 8 show the preferred embodiment for flexible sleeve 20 with longitudinally extending edges 24 and 26. Edges 24 and 26 are wound over each other. Transversal cuts 27, 28 and 29 are cooperatively and repeatedly positioned to facilitate cutting sleeve 20 at predetermined lengths and to permit bending sleeve 20 in all planes. Edge transversal cuts 27 and 29 repeat and alternate from edges 24 and 26, respectively. Central transversal cut 28 extends from the center towards edges 24 and 26. The distance of edge transversal cuts 27 and 29 are, in the preferred embodiment, between one fourth and one third of the width of sleeve 20. Central transversal cut 28 extends between one third and one half of the width of sleeve 20, in the preferred embodiment. The alternated cuts, in sum, extend about the same width of sleeve 20 in the preferred embodiment. The disposition of transversal cuts 27, 28 and 29 also defines interconnected annular members 25, as best seen in FIG. 8. Interconnected annular members 25 make cable sleeve 20 flexible enough to be mounted to cylindrical halves 34 and 44. When flexible cable sleeve 20 is closed edge 24 overlap edge 26, as best seen in FIGS. 3 and 5. Other equivalent sleeves can also be used with tool 10.

To mount flexible sleeve 20 to wires W, a user presses handle members 38 and 48, causing cylindrical halves 34 and 44, as well as half tubular members 36 and 46, to separate overcoming the bias of spring member 50. The separation is sufficient to permit the insertion of wires W therethrough and when released, the entire bunch of wires W is kept in place, as seen in FIG. 2. As best seen in FIG. 3, when tool 10 is positioned, the user brings sleeve 20 against round ends 35 and 45 causing the former to cammingly separate its longitudinally extending edges 24 and 26. As sleeve 20 advances towards wires W the former embraces them.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. (canceled)

2. (canceled)

3. (canceled)

4. A tool for mounting a flexible sleeve with two longitudinally extending edges, comprising:
A) first and second members, each including a complementary half cylindrical portion with first and second ends said first end being open and said second end being wound, an adjacent complementary half tubular portion extending at a predetermined angle from said half cylindrical portions and having third and fourth ends and said first and third ends being common and open and a handle portion extending therefrom, said first and second members being hingedly mounted to each other between said handle and tubular portions; and
B) spring means for biasing said first and second members to urge said complementary longitudinal half cylindrical and tubular portions against each other so that at least one wire can be received within said complementary half tubular members when said spring means is overcame and when released said second ends come toward each other forming a round surface for cammingly separating a flexible sleeve with two longitudinally extending edges that is slidably advanced over said wires extending outside said third ends thereby embracing said wires.

5. The tool set forth in claim 4 wherein said predetermined angle is between 15 and 60 degrees.

6. The tool set forth in claim 5 wherein said handle includes a through opening and said spring means includes a spring member that passes through said through openings coating with said tubular members urging them against each other.

7. The tool set forth in claim 6 wherein said angle is approximately 30 degrees.
